(19) United States
(12) Patent Application Publication
(10) Pub. No.: US 2014/0040678 A1
(43) Pub. Date: Feb. 6, 2014

(54) STORAGE DEVICE AND METHOD FOR MANAGING STORAGE DEVICE

(71) Applicant: FUJITSU LIMITED, Kawasaki-shi (JP)

(72) Inventor: Satoshi KUBOTA, Yokohama (JP)

(73) Assignee: FUJITSU LIMITED, Kawasaki-shi (JP)

(21) Appl. No.: 13/955,696

(22) Filed: Jul. 31, 2013

(30) Foreign Application Priority Data
Aug. 6, 2012 (JP) 2012-173522

(51) Int. Cl. G06F 11/07

(52) U.S. Cl. CPC G06F 11/0787
USPC 714/54

(57) ABSTRACT

A storage device includes a plurality of control devices to control writing data into one or more storages. Each of the plurality of control devices includes an interface unit and a processor. The interface unit transmits and receives data. The processor acquires first checking information added to first data to be written into a first storage. The processor acquires second checking information calculated based on the first data. The processor compares the first checking information and the second checking information. The processor reports an error by way of the interface unit when a result of the comparison indicates inconsistency between the first checking information and the second checking information.

### CROSS-REFERENCE TO RELATED APPLICATION

This application is based upon and claims the benefit of priority from the prior Japanese Patent Application No. 2012-173522 filed on Aug. 6, 2012, the entire contents of which are incorporated herein by reference.

### FIELD

The embodiments discussed herein are related to a storage device and a method for managing a storage device.

### BACKGROUND

In some storage devices, a channel adapter (CA) of a storage device receives data from a host device, and the CA calculates a block check code (BCC) used for checking the consistency of the data.

Here, the BCC is a code that is added to each data block of a predetermined size in order to check data consistency.

For example, an 8-byte BCC is added to each 512-byte data block.

For example, data having the structure depicted in FIG. 8 is generated.

FIG. 8 is a schematic diagram depicting the data structure of a data block 100.

In FIG. 8, the data block 100 has a 512-byte data section 103, and an 8-byte BCC section 105.

The data section 103 is the data itself that is exchanged between the host device and the storage device, and the data section 103 has a data block format.

The BCC section 105 is a BCC that is used in order to check the consistency of the data of the data section 103, and the BCC section 105 has a BCC data format.

In the example depicted in FIG. 8, the BCC section 105 has, for example, a 16-bit block cyclic redundancy code (CRC) 107, a 1-bit bad flag 111, a 1-bit parity bit 113, a 6-bit secondary logical unit (SLU) number 115, an 8-bit identifier (ID) section 117, and a 32-bit counter 119.

In a storage device equipped with a plurality of controller modules (CMs), generally, data received by a CM via a CA is transmitted to another CM, and mirror data is retained by the plurality of CMs.

Next, processing will be described for the case in which data has been transmitted from a host device to a storage device, with reference to FIG. 9.

FIG. 9 is a flowchart of the processing for the case in which data has been transmitted from a host device to a storage device.

In S101 in FIG. 9, a CA receives a write command including data, from the host device. In this process, the CA receives the total number of blocks of the data.

In S103, the CA divides the data received from the host device into blocks at each 512 bytes and creates 8-byte BCCs to generate 520-byte data blocks. The CA starts to transmit these data blocks to the mirror source CM.

In S105, the mirror source CM sets a data counter indicating the number of data blocks completely received from the host device to zero.

In S107, the mirror source CM receives a 520-byte data block from the CA. The data block transferred to the mirror source CM has a BCC added thereto that includes a block CRC (hereafter simply referred to as a CRC) 107 calculated by the CA.

In S109, the mirror source CM transmits a copy of the data block to a CM (hereafter referred to as a mirror destination CM), which mirrors the data, and the copy is stored as mirror data in the mirror destination CM.

In S111, the mirror source CM determines whether or not the data has been processed normally by the mirror destination CM.

When the data has been processed normally by the mirror destination CM (YES in S111), in S113 the mirror source CM increments the data counter by one.

When the data counter is equal to the total number of blocks (YES in S115), in S117 the CA issues a data reception completion response to the host device.

When the data counter is not equal to the total number of blocks (NO in S115), because there is an unprocessed data block, the mirror source CM returns to S107, and the processing from S107 to S115 is repeated.

When the data has not been processed normally by the mirror destination (NO in S111), in S119 the CA issues a data reception failure response to the host device.

Therefore, it is desirable to shorten the response time from the storage device to the host device.

Japanese Laid-open Patent Publication No. 2002-23966 discloses a related technique.

### SUMMARY

According to an aspect of the present invention, provided is a storage device including a plurality of control devices to control writing data into one or more storages. Each of the plurality of control devices includes an interface unit and a processor. The interface unit transmits and receives data. The processor acquires first checking information added to first data to be written into a first storage. The processor acquires second checking information calculated based on the first data. The processor compares the first checking information and the second checking information. The processor reports an error by way of the interface unit when a result of the comparison indicates inconsistency between the first checking information and the second checking information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram depicting a hardware configuration of a storage system as an example of a first embodiment;

FIG. 2 is a block diagram depicting a functional configuration of a CM as an example of a first embodiment;

FIG. 3 is a flowchart depicting processing in a mirror source CM in a storage device as an example of a first embodiment;

FIG. 4 is a flowchart depicting processing in a mirror destination CM in a storage device as an example of a first embodiment;

FIG. 5 is a flowchart depicting processing of erasing mirror data in a mirror destination CM in a storage device as an example of a first embodiment;

FIG. 6 is a block diagram depicting a functional configuration of a CM as an example of a second embodiment;

FIG. 7 is a flowchart depicting processing of a mirror source CM in a storage device as an example of a second embodiment;

FIG. 8 is a diagram depicting a format of a data block in a storage device;

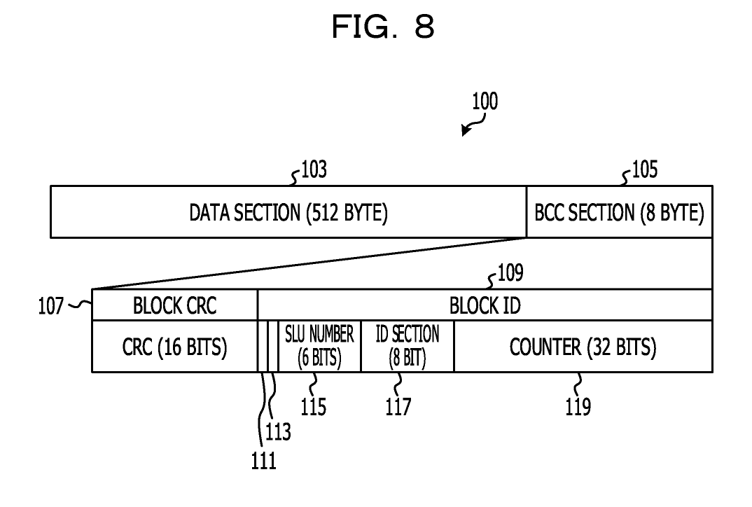

FIG. 9 is a flowchart depicting processing in a conventional storage device; and

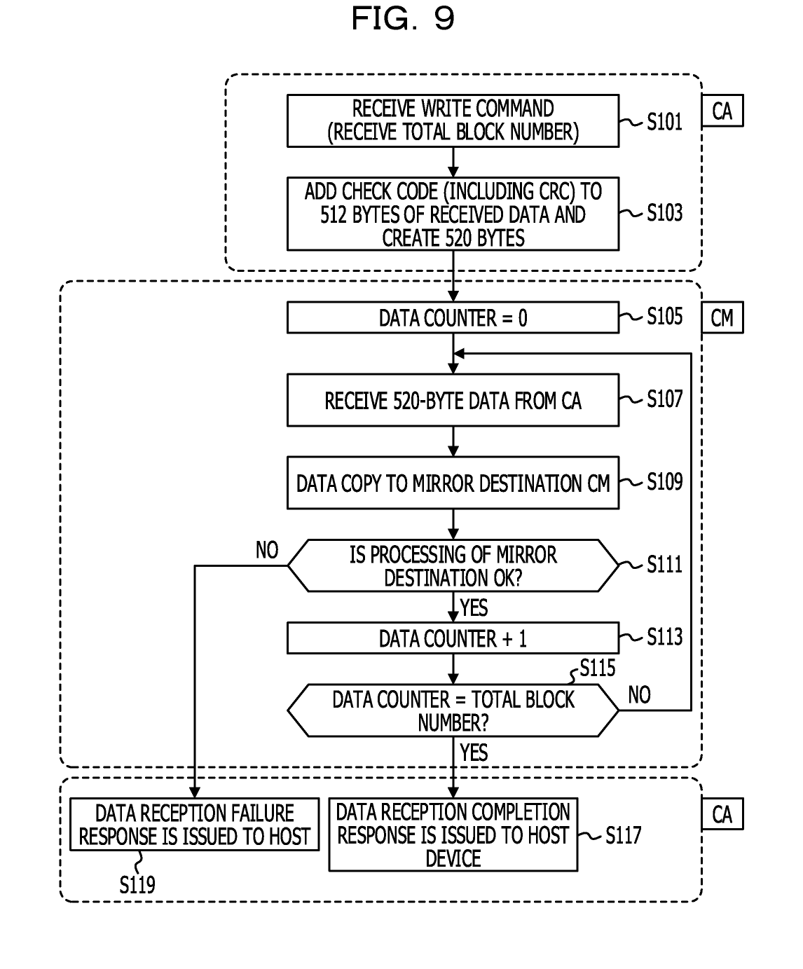

FIG. 10 is a flowchart depicting processing in a storage device.

### DESCRIPTION OF EMBODIMENTS

Hereafter, embodiments with respect to a storage device and a control device will be described with reference to the drawings. However, the embodiments indicated below are merely examples, and are not intended to exclude various modified examples or applications of technology not explicitly indicated in the embodiments. In other words, the present embodiments may be implemented with various modifications (by combining the embodiments and modified examples, and so on) without deviating from the purpose of the present embodiments.

### First Embodiment

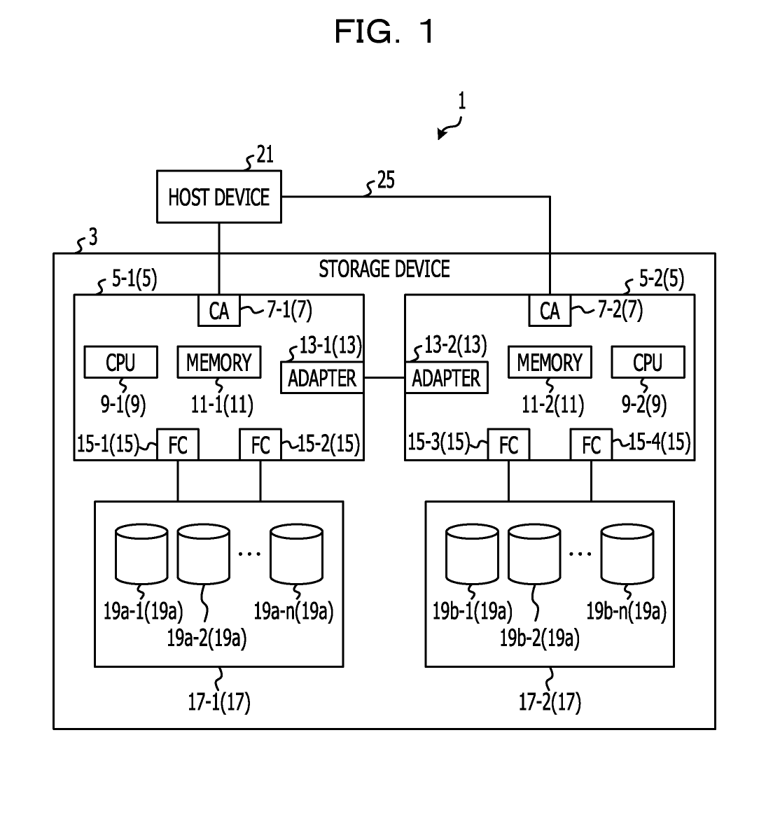

FIG. 1 is a schematic diagram depicting a hardware configuration of a storage system 1 as an example of a first embodiment.

The storage system 1 is provided with a storage device 3 and a host device 21.

The storage device 3 provides a storage area for the host device 21, and the storage device 3 and the host device 21 are communicably connected to each other by way of a communication network 25.

As depicted in FIG. 1, the storage device 3 is provided with CMs 5-1 and 5-2 and drive enclosures 17-1 and 17-2.

The CM 5-1 and the CM 5-2 are control devices that control operations within the storage device 3 and receive commands such as read/write commands from the host device 21 and carry out various forms of control.

The CM 5-1 has a CA 7-1 as an interface unit, a central processing unit (CPU) 9-1 as a control unit, memory 11-1, an adapter 13-1, and Fibre Channel (FC) interfaces 15-1 and 15-2.

The CM 5-2 has a CA 7-2, a CPU 9-2, memory 11-2, an adapter 13-2, and FC interfaces 15-3 and 15-4.

The drive enclosures 17-1 and 17-2 are provided with a plurality of hard disk drives (HDDs) 19a-1 to 19a-n and 19b-1 to 19b-n (n is an integer of 1 or more) as storages.

The CM 5-1 and the CM 5-2 are connected to the host device 21 via the network by way of the CA 7-1 and the CA 7-2, respectively. The CMs 5-1 and 5-2 receive commands such as read/write commands transmitted from the host device 21, and control the HDDs 19a-1 to 19a-n and 19b-1 to 19b-n by way of an expander or the like which is not depicted.

The CMs 5-1 and 5-2 have substantially the same configuration.

The host device 21 is, for example, a higher-level device such as a computer (information processing apparatus) provided with server functionality, and uses Transmission Control Protocol/Internet Protocol (TCP/IP) to transmit and receive a variety of data such as small computer system interface (SCSI) commands and responses between the host device 21 and the storage device 3. The host device 21 transmits a disk access command such as a read/write command to the storage device 3, and thereby writes and reads data in the storage area provided by the storage device 3.

The HDDs 19a-1 to 19a-n and 19b-1 to 19b-n are storage devices that store data in a readable and writable manner, and function as storage units that are able to store data received from the host device 21. The storage device 3 may be a redundant array of inexpensive disks (RAID) device that combines and manages the plurality of HDDs 19a-1 to 19a-n and 19b-1 to 19b-n as a single redundant storage.

Hereafter, as reference numerals representing the CMs, the reference numerals 5-1 and 5-2 are used when the occasion calls to specify one CM from among the plurality of CMs; however, when an arbitrary CM is being referred to, the reference numeral 5 is used.

Furthermore, hereafter, as reference numerals representing the CAs, the reference numerals 7-1 and 7-2 are used when the occasion calls to specify one CA from among the plurality of CAs; however, when an arbitrary CA is being referred to, the reference numeral 7 is used.

Furthermore, hereafter, as reference numerals representing the CPUs, the reference numerals 9-1 and 9-2 are used when the occasion calls to specify one CPU from among the plurality of CPUs; however, when an arbitrary CPU is being referred to, the reference numeral 9 is used.

Furthermore, hereafter, as reference numerals representing the memories, the reference numerals 11-1 and 11-2 are used when the occasion calls to specify one memory from among the plurality of memories; however, when an arbitrary memory is being referred to, the reference numeral 11 is used.

Furthermore, hereafter, as reference numerals representing the adapters, the reference numerals 13-1 and 13-2 are used when the occasion calls to specify one adapter from among the plurality of adapters; however, when an arbitrary adapter is being referred to, the reference numeral 13 is used.

Furthermore, hereafter, as reference numerals representing the FC interfaces, the reference numerals 15-1 to 15-4 are used when the occasion calls to specify one FC interface from among the plurality of FC interfaces; however, when an arbitrary FC interface is being referred to, the reference numeral 15 is used.

Furthermore, hereafter, as reference numerals representing the drive enclosures, the reference numerals 17-1 and 17-2 are used when the occasion calls to specify one drive enclosure from among the plurality of drive enclosures; however, when an arbitrary drive enclosure is being referred to, the reference numeral 17 is used.

Furthermore, hereafter, as reference numerals representing the HDDs, the reference numerals 19a-1 to 19a-n and 19b-1 to 19b-n are used when the occasion calls to specify one HDD from among the plurality of HDDs; however, when an arbitrary HDD is being referred to, the reference numeral 19 is used.

The CAs 7 are interface controllers (communication adapters) that communicably connect to the host device 21 and so on. The CAs 7 receive data transmitted from the host device 21 and so on, and transmit data output from the CMs 5 to the host device 21 and so on. That is, the CAs 7 control the input and output (I/O) of data between the CAs 7 and an external device such as the host device 21.

When data is received from the host device 21, the CAs 7 divide the received data into data blocks of a predetermined size (for example, 512-byte data blocks), calculate a CRC and add a BCC with respect to each data block, and transmit the data blocks to the CMs 5 described hereafter. CRC calculation does not have to be carried out if a CRC is attached to the received data.

The memories 11 are storage devices that store a program executed by the CPUs 9 and store a variety of data. The memories 11 may be read-only memories (ROMs) or random access memories (RAMs).

The adapters 13 are interfaces for communicably connecting the CMs 5. The FC interfaces 15 are interfaces for communicably connecting a CM 5 and a drive enclosure 17 and so on, and are provided with a device adapter or the like. The CMs 5 write and read data with respect to an HDD 19 by way of an FC interface 15.

The CPUs 9 are processing devices that carry out a variety of control and calculations, and implement various functions by executing a program stored in the memory 11. For example, the CPUs 9 implement various functions as known disk controllers, such as the implementation of RAID, and access control to the HDDs 19 in accordance with host I/O from the host device 21.

Although two CMs 5 are provided in the storage device 3 depicted in FIG. 1, three or more CMs may be provided.

In order to detect data corruption within the storage device 3, it is desirable to add the CRC 107 as soon as possible after the storage device 3 receiving data from the host device 21. Therefore, as previously mentioned, the CRC 107 is added by a CA 7 immediately after the data is received.

Furthermore, in the storage device 3 as an example of the present embodiment, in modules other than the CAs 7 inside the storage device 3, CRCs are calculated from data blocks, and checking is carried out as to whether or not these CRCs match the CRCs 107 added by the CAs 7.

As previously mentioned, the data reception completion response to the host device 21 is conventionally reported by the storage device 3 after the mirror data has been completely stored.

However, in the conventional method, there is the problem in that there are cases in which an incorrect CRC (error CRC) is added as a result of a correct CRC not being calculated and so on due to a fault in a CA 7.

When data and an error CRC are transferred to the mirror destination CM 5-2 and mirror data is stored in the mirror destination CM 5-2, although a data reception completion response is reported to the host device 21, error data is retained by the storage device 3. When the storage device 3 examines the CRCs and detects an error, this data is treated as an abnormality; however, because a data reception completion response has already been issued to the host device 21, data loss occurs.

In order to avoid this kind of situation, in the present embodiment, immediately after a certain CM 5 has received data by way of a CA 7, the CRC (second checking information) is recalculated by another internal circuit of this CM 5 and also by another CM 5. A comparison is then made with the CRC (first checking information) added by the CA 7 that received the data, and checking is carried out as to whether or not there are any errors. In this process, CRC recalculation processing is distributed between the plurality of CMs 5, and it is therefore possible to shorten the response time to the host device 21.

The functions of a CM 5 (for example, CM 5-1 and 5-2 in FIG. 1) provided with this kind of functionality as an example of the first embodiment will now be described.

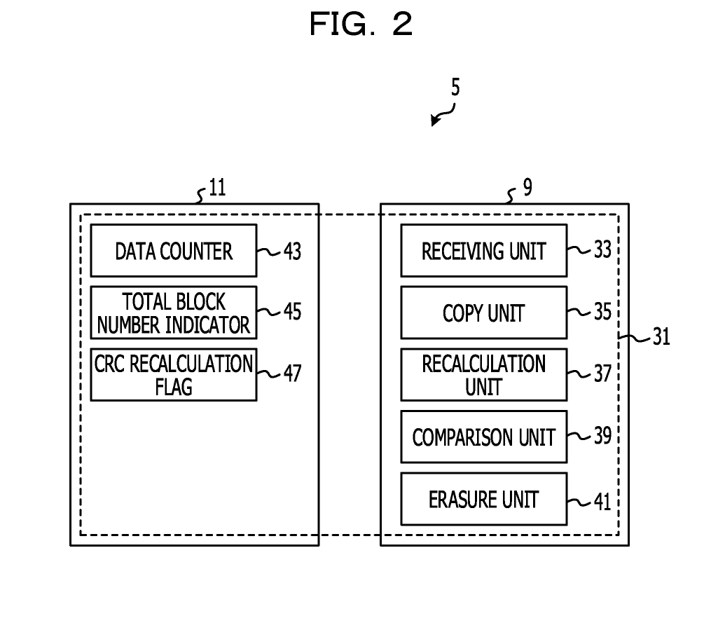

FIG. 2 is a block diagram depicting a functional configuration of a CM 5 as an example of the first embodiment.

As depicted in FIG. 2, the CM 5 has a processing unit 31.

As depicted in FIG. 2, a CPU 9 (see FIG. 1) functions as a receiving unit 33, a copy unit 35, a recalculation unit (calculation unit) 37, a comparison unit 39, and an erasure unit 41 of the processing unit 31.

The memory 11 (see FIG. 1) functions as a data counter 43, a total block number indicator 45, and a CRC recalculation flag 47.

The receiving unit 33 receives, from the CA 7 of this CM 5, data transmitted from the host device 21.

The copy unit 35 transfers, to another CM 5, a copy of a data block received by the receiving unit 33, and this copy is stored as mirror data in the other CM 5.

The recalculation unit 37 calculates (hereafter, the calculation by the recalculation unit 37 is referred to as recalculation) the CRC 107 of the data block received from the host device 21, and the calculated CRC 107 is stored in the memory 11.

The comparison unit 39 compares the CRC (first checking information) 107 within the BCC 105 added by the CA 7 and the CRC (second checking information) 107 calculated by the recalculation unit 37.

As the result of comparison conducted by the comparison unit 39, if the CRC 107 within the BCC 105 added by the CA 7 and the CRC 107 calculated by the recalculation unit 37 do not match, the erasure unit 41 erases that data.

To be specific, the erasure unit 41 of the mirror source CM 5 issues notification of invalid mirror processing to the mirror destination CM 5 if the CRCs do not match (CRC error), and causes the mirror destination CM 5 to erase the mirror data. The erasure unit 41 of the mirror destination CM 5 erases the mirror data when invalid mirror processing has been notified from the mirror source CM 5.

The data counter 43 is a counter for data blocks received from the host device 21, and indicates the number of data blocks completely received from the host device 21.

The total block number indicator 45 retains a numerical value indicating the total number of data blocks to be transmitted from the host device 21.

The CRC recalculation flag 47 is a flag indicating whether or not recalculation of the CRC 107 by the recalculation unit 37 of this CM 5 is to be carried out. For example, when the value of the CRC recalculation flag 47 is OFF (for example, “0”), the recalculation unit 37 does not carry out recalculation of the CRC 107, and when the value of the CRC recalculation flag 47 is ON (for example, “1”), the recalculation unit 37 carries out recalculation of the CRC 107.

As described hereafter, the mirror destination CM 5 refers to the CRC recalculation flag 47 of the mirror source CM 5, and thereby determines whether CRC recalculation processing is to be carried out by the mirror source CM 5 or the mirror destination CM 5.

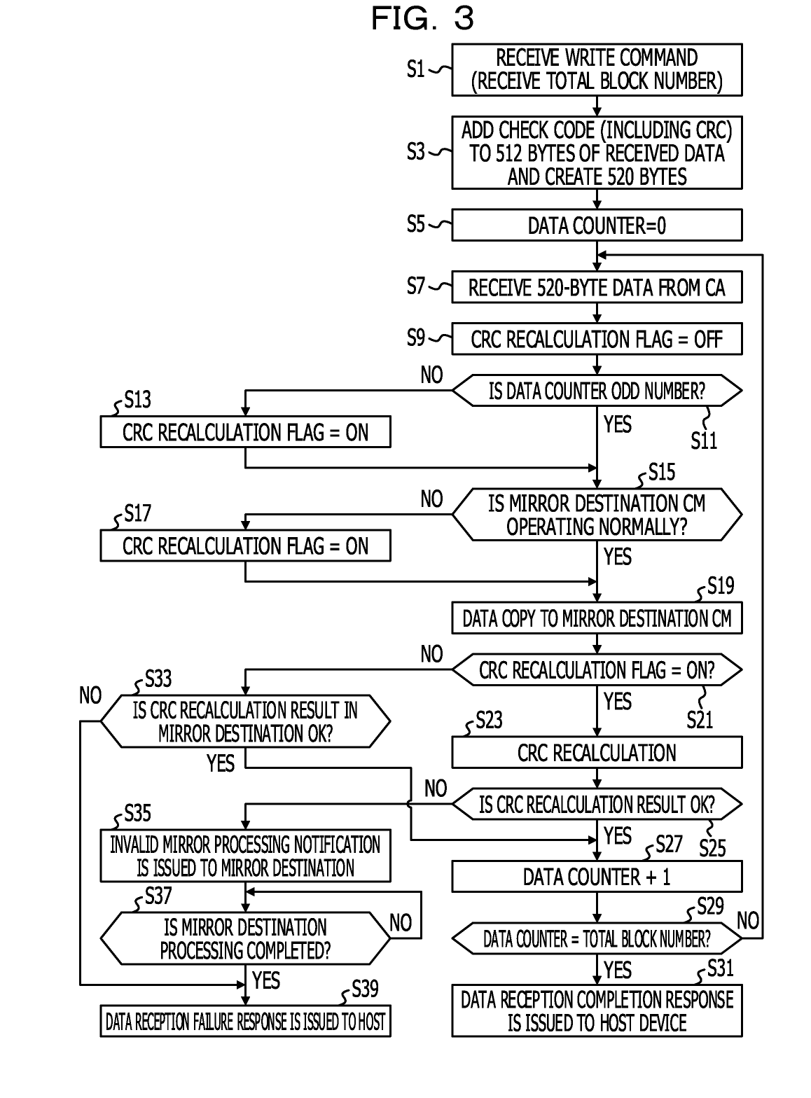

Processing in the storage device 3 as an example of the first embodiment and configured as mentioned above will now be described with reference to FIG. 3.

The following considers the case in which the CM 5-1 of FIG. 1 receives data to be written from the host device 21 via the CA 7-1, and the data is mirrored in the CM 5-2. In this case, the CM 5-1 is referred to as the mirror source CM, and the CM 5-2 is referred to as the mirror destination CM.

FIG. 3 is a flowchart depicting processing of the mirror source CM 5-1 in the storage device 3 as an example of the first embodiment.

In S1 in FIG. 3, the CA 7-1 of the mirror source CM 5-1 receives a write command including data, from the host device 21. In this process, the CA 7-1 receives the total number of blocks of the data, and stores this value in the total block number indicator 45.

In S3, the CA 7-1 divides the data received from the host device 21 into blocks at each 512 bytes, and creates 8-byte BCCs to generate 520-byte data blocks.

In S5, the CA 7-1 resets the data counter 43 to zero.

In S7, the receiving unit 33 of the mirror source CM 5-1 receives a 520-byte data block from the CA 7-1. The data block transferred to the mirror source CM 5-1 has a BCC 105 added thereto that includes a CRC 107 calculated by the CA 7-1.

In S9, the receiving unit 33 of the mirror source CM 5-1 sets the CRC recalculation flag 47 to OFF.

In S11, the receiving unit 33 of the mirror source CM 5-1 determines whether or not the data counter 43 is an odd number.

When the data counter 43 is an odd number (YES in S11), processing moves to S15 described hereafter.

When the data counter 43 is an even number (NO in S11), in S13 the copy unit 35 of the mirror source CM 5-1 sets the CRC recalculation flag 47 to ON, and processing moves to S15.

In S15, the copy unit 35 of the mirror source CM 5-1 determines whether or not the mirror destination CM 5-2 is operating normally. This determination is, for example, carried out by communication between the CMs.

When the mirror destination CM 5-2 is operating normally (YES in S15), processing moves to S19 described hereafter.

When an abnormality has been detected by the CM 5-2 (NO in S15), in S17 the copy unit 35 of the mirror source CM 5-1 sets the CRC recalculation flag 47 to ON, and processing moves to S19.

In S19, the copy unit 35 of the mirror source CM 5-1 transmits a copy of the data block to the mirror destination CM 5-2, and the copy is stored as mirror data in the mirror destination CM 5-2.

In S21, the recalculation unit 37 of the mirror source CM 5-1 determines whether or not the CRC recalculation flag 47 is ON.

When the CRC recalculation flag 47 is ON (YES in S21), in S23 the recalculation unit 37 of the mirror source CM 5-1 recalculates the CRC 107 of the data block received from the CA 7-1.

In S25, the comparison unit 39 of the mirror source CM 5-1 compares the CRC 107 recalculated in S23 and the CRC 107 included in the data received from the CA 7-1, and determines whether or not these CRCs 107 match.

When the CRCs 107 match (YES in S25), in S27 the comparison unit 39 of the mirror source CM 5-1 increments the data counter 43 by one.

When the CRCs 107 do not match (NO in S25), processing moves to S35 described hereafter.

Next, in S29, the comparison unit 39 of the mirror source CM 5-1 determines whether or not the value of the data counter 43 is equal to the value of the total block number indicator 45.

When the value of the data counter 43 is not equal to the value of the total block number indicator 45 (NO in S29), because there is an unreceived data block, processing returns to the aforementioned S7, and the reception of the remaining data blocks is continued.

When the value of the data counter 43 is equal to the value of the total block number indicator 45 (YES in S29), because all of the data blocks have been completely received, in S31 the CA 7-1 issues a data reception completion response to the host device 21.

When the CRC recalculation flag 47 is OFF (NO in S21), recalculation of the CRC 107 is carried out by the recalculation unit 37 of the mirror destination CM 5-2.

In S33, the recalculation unit 37 of the mirror source CM 5-1 determines whether or not the CRC 107 recalculated in the mirror destination CM 5-2 matches the CRC 107 added by the CA 7-1.

When the CRC 107 recalculated in the mirror destination CM 5-2 matches the CRC 107 added by the CA 7-1 (YES in S33), processing moves to S27 described above.

When the CRC 107 recalculated in the mirror destination CM 5-2 does not match the CRC 107 added by the CA 7-1 (NO in S33), processing moves to S39 described hereafter.

When the CRCs 107 do not match (NO in S25), in S35 the erasure unit 41 of the mirror source CM 5-1 issues notification of invalid mirror processing to the mirror destination CM 5-2.

Next, in S37, the mirror source CM 5-1 determines whether or not the processing of the mirror destination CM 5-2 has been completed.

When the processing of the mirror destination CM 5-2 has not been completed (NO in S37), processing returns to S37.

When the processing of the mirror destination CM 5-2 has been completed (YES in S37), in S39 a CA 7 issues a data reception failure response to the host device 21.

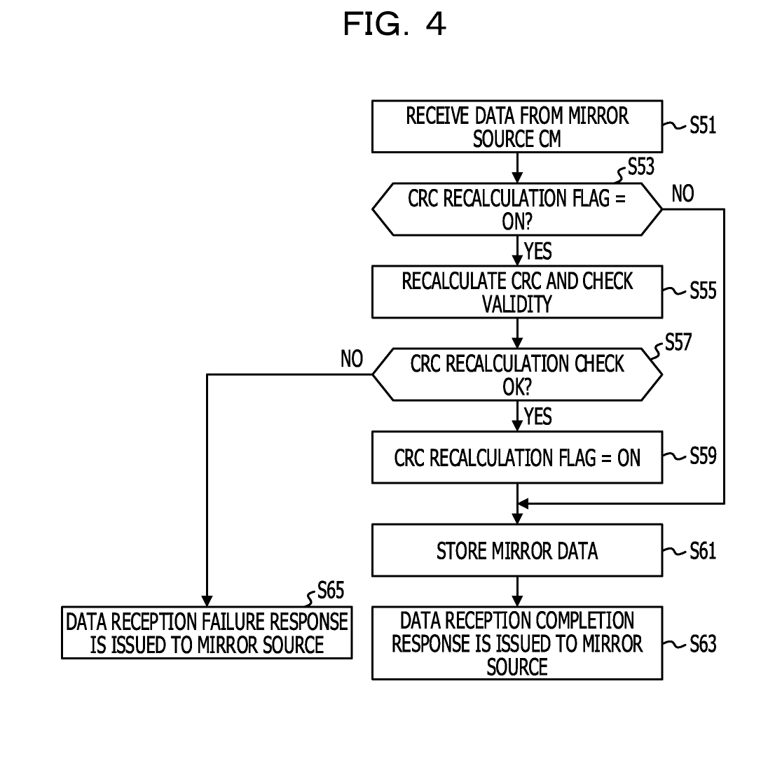

Next, the processing of the mirror destination CM 5-2 in the storage device 3 in FIG. 1 will be described with reference to FIG. 4.

FIG. 4 is a flowchart depicting processing of the mirror destination CM 5-2 in the storage device 3 as an example of the first embodiment.

In S51, the receiving unit 33 of the mirror destination CM 5-2 receives a 520-byte data block from the mirror source CM 5-1. The data block transferred to the mirror destination CM 5-2 has a BCC 105 added thereto that includes a CRC 107 calculated by the CA 7-1 of the mirror source CM 5-1.

In S53, the recalculation unit 37 of the mirror destination CM 5-2 refers to the CRC recalculation flag 47 of the mirror source CM 5-1 and determines whether or not the CRC recalculation flag 47 is ON.

When the CRC recalculation flag 47 of the mirror source CM 5-1 is OFF (NO in S53), processing moves to S61 described hereafter.

When the CRC recalculation flag 47 of the mirror source CM 5-1 is ON (YES in S53), in S55 the recalculation unit 37 of the mirror destination CM 5-2 recalculates the CRC 107 of the data received from the mirror source CM 5-1.

In S57, the comparison unit 39 of the mirror source CM 5-1 compares the CRC 107 recalculated in S55 and the CRC 107 included in the data received from the mirror source CM 5-1, and determines whether these CRCs 107 match.

When the CRCs 107 match (YES in S57), in S59 the comparison unit 39 of the mirror destination CM 5-2 sets the CRC recalculation flag 47 to ON.

In S61, the data is stored as mirror data in the mirror destination CM 5-2.

In S63, the mirror destination CM 5-2 issues a data reception completion response to the mirror source CM 5-1.

When the CRCs 107 do not match (NO in S57), in S65 the comparison unit 39 of the mirror destination CM 5-2 issues a data reception failure response to the mirror source CM 5-1.

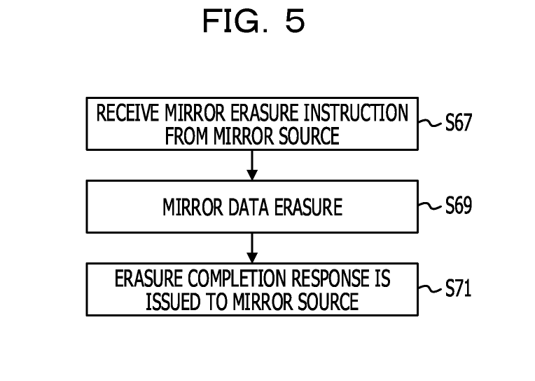

Next, the processing of erasing mirror data in the mirror destination CM 5-2 in the storage device 3 in FIG. 3 will be described with reference to FIG. 5.

FIG. 5 is a flowchart depicting processing of erasing mirror data in the mirror destination CM 5-2 in the storage device 3 as an example of the first embodiment.

In S67, the mirror destination CM 5-2 receives a mirror data erasure instruction from the mirror source CM 5-1.

In S69, the erasure unit 41 of the mirror destination CM 5-2 erases the mirror data.

Next, in S71, the erasure unit 41 of the mirror destination CM 5-2 issues an erasure completion response to the mirror source CM 5-1.

According to the example of the first embodiment, because the CRC recalculation is distributed between the plurality of CMs 5, it is possible to shorten the response time from the storage device 3 to the host device 21.

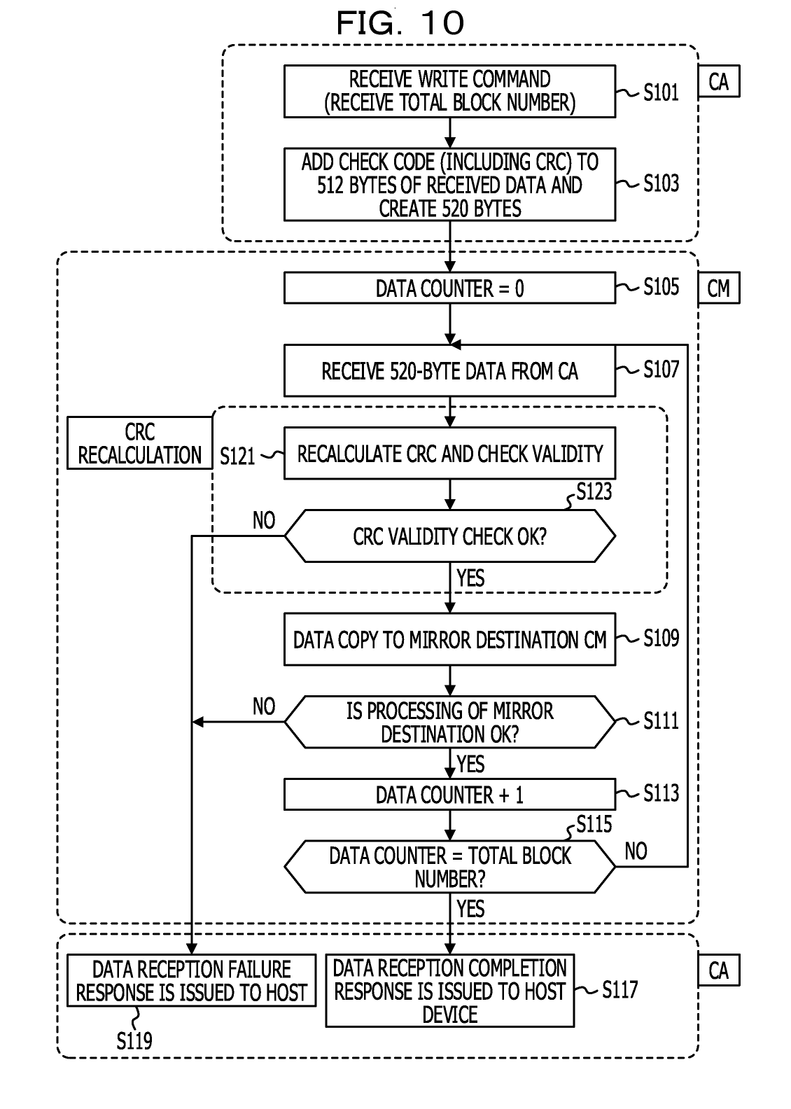

For the purpose of comparison, with reference to FIG. 10, the following considers the case in which CRC recalculation is carried out in a centralized manner by the CPU 9-1 of the mirror source CM 5-1.

FIG. 10 is a flowchart of processing for the case in which data has been transmitted from the host device 21 to the storage device 3.

In S101 in FIG. 10, the CA 7-1 receives a write command including data, from the host device 21. In this process, the CA 7-1 receives the total number of blocks of the data.

In S103, the CA 7-1 divides the data received from the host device 21 into blocks at each 512 bytes, and creates 8-byte BCCs to generate 520-byte data blocks. The CA 7-1 starts to transmit these data blocks to the mirror source CM 5-1.

In S105, the mirror source CM 5-1 sets a data counter indicating the number of data blocks completely received from the host device 21 to zero.

In S107, the CPU 9-1 of the mirror source CM 5-1 receives a 520-byte data block from the CA 7-1. The data block transferred to the CPU 9-1 of the mirror source CM 5-1 has a BCC 105 added thereto that includes a CRC 107 calculated by the CA 7-1.

In S121, the CPU 9-1 of the mirror source CM 5-1 recalculates the CRC 107 of the data received from the CA 7-1.

In S123, the CPU 9-1 of the mirror source CM 5-1 compares the CRC 107 recalculated in S121 and the CRC 107 included in the data received from the CA 7-1.

When the CRCs 107 do not match (NO in S123), in S119 the CA 7-1 issues a data reception failure response to the host device 21.

When the CRCs 107 match (YES in S123), in S109 the CPU 9-1 of the mirror source CM 5-1 transmits a copy of the data block to the mirror destination CM 5-2, and the copy is stored as mirror data in the mirror destination CM 5-2.

In S111, the CPU 9-1 of the mirror source CM 5-1 determines whether or not the data has been processed normally by the mirror destination CM 5-2.

When the data has been processed normally by the mirror destination CM 5-2 (YES in S111), in S113 the CPU 9-1 of the mirror source CM 5-1 increments the data counter by one. This data counter is initialized to zero in S105 before the reception of data from the CA 7-1 is started.

When the data counter is equal to the total number of blocks (YES in S115), in S117 the CA 7-1 issues a data reception completion response to the host device 21.

When the data counter is not equal to the total number of blocks (NO in S115), because there is an unprocessed data block, the CPU 9-1 of the mirror source CM 5-1 returns to S107, and the processing from S107 to S115 is repeated.

When the data has not been processed normally by the mirror destination CM 5-2 (NO in S111), in S119 the CA 7-1 issues a data reception failure response to the host device 21.

In the method of FIG. 10, because all of the CRC recalculations are carried out by the CPU 9-1 in the mirror source CM 5-1 that has received data, the load on the CPU 9-1 of the mirror source CM 5-1 increases, and there are cases in which the response to the host device 21 is delayed. To be specific, the CPU 9-1 of the mirror source CM 5-1 issues a data reception completion response to the host device 21 after carrying out CRC recalculation and completing checking, and therefore there are cases in which the response time increases depending on the processing state.

In contrast to this, in the storage device 3 as an example of the first embodiment, because the CRC recalculation is distributed and carried out by a plurality of the CMs 5, it is possible to shorten the response time from the storage device 3 to the host device 21.

In addition, because CRC calculation for data blocks received from a CA 7 is carried out again by a CM 5, the reliability of the data is improved.

In addition, because data of both the mirror source and mirror destination CMs 5 is erased by the erasure unit 41 when a CRC error occurs, data consistency may be ensured.

### Second Embodiment

In the storage device 3 as an example of the aforementioned first embodiment, CRC recalculation is carried out in rotation among CMs 5; however, in the example of a second embodiment, CRC recalculation is carried out depending on the loads of the CMs 5, that is, a CM 5 having a low load recalculates the CRC.

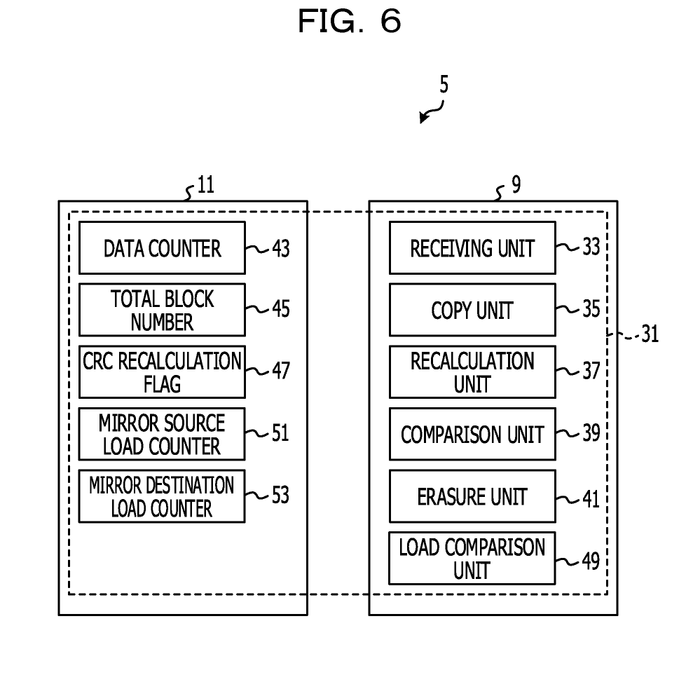

FIG. 6 is a block diagram depicting a functional configuration of a CM 5 as an example of the second embodiment.

In FIG. 6, reference numerals that are similar to in FIG. 2 indicate portions that are similar, and therefore a detailed description thereof will be omitted.

As depicted in FIG. 6, the CM 5 depicted in FIG. 6 has a load comparison unit 49, a mirror source load counter 51, and a mirror destination load counter 53, in addition to the constituent elements depicted in FIG. 2.

The load comparison unit 49 monitors and compares the processing load in the mirror source CM 5-1 and the processing load in the mirror destination CM 5-2. For example, the load comparison unit 49 monitors the number of processes being executed by the mirror source CM 5-1 and the mirror destination CM 5-2. For example, the load comparison unit 49 stores the number of processes being executed by the CPU 9-1 of the mirror source CM 5-1 in the mirror source load counter 51 described hereafter. Furthermore, the load comparison unit 49 stores the number of processes being executed by the CPU 9-2 of the mirror destination CM 5-2 in the mirror destination load counter 53 described hereafter. Moreover, the load comparison unit 49 compares the value of the mirror source load counter 51 described hereafter and the value of the mirror destination load counter 53.

The function of this load comparison unit 49 is implemented by a CPU 9 (see FIG. 1).

The mirror source load counter 51 is a counter indicating the load of the mirror source CM 5-1, and is implemented by the memory 11 (see FIG. 1).

The mirror destination load counter 53 is a counter indicating the load of the mirror destination CM 5-2, and is implemented by the memory 11 (see FIG. 1).

The mirror source load counter 51 is reset to zero when the mirror source CM 5-1 is activated.

The mirror destination load counter 53 is also reset to zero when the mirror destination CM 5-2 is activated.

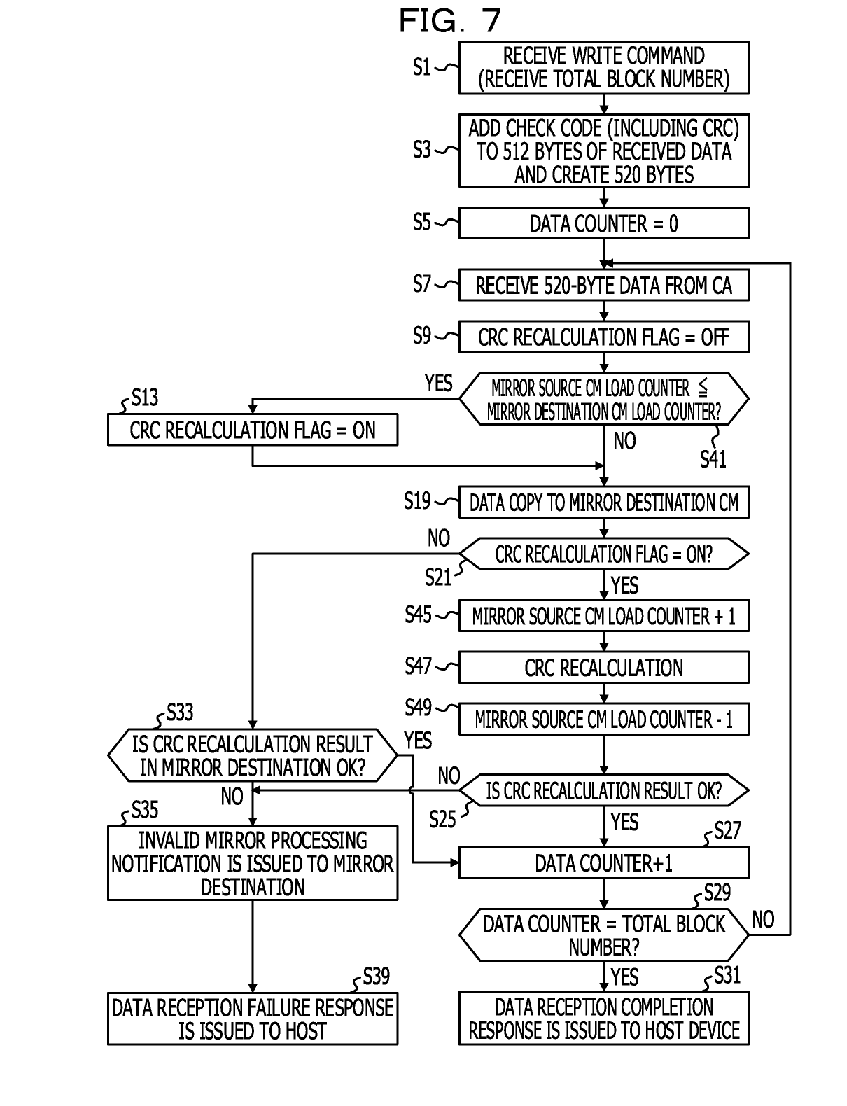

Processing in the storage device 3 as an example of the second embodiment and configured as mentioned above will now be described with reference to FIG. 7.

The following considers the case in which, in a similar way in the first embodiment, the mirror source CM 5-1 receives data to be written from the host device 21 via the CA 7-1, and the data is mirrored in the mirror destination CM 5-2.

FIG. 7 is a flowchart depicting processing of the mirror source CM 5-1 in the storage device 3 as an example of the second embodiment.

In S1 in FIG. 7, the CA 7-1 of the mirror source CM 5-1 receives a write command including data, from the host device 21. In this process, the CA 7-1 receives the total number of blocks of the data, and stores this value in the total block number indicator 45.

In S3, the CA 7-1 divides the data received from the host device 21 into blocks at each 512 bytes, and creates 8-byte BCCs to generate 520-byte data blocks.

In S5, the CA 7-1 resets the data counter 43 to zero.

In S7, the receiving unit 33 of the mirror source CM 5-1 receives a 520-byte data block from the CA 7-1. The data block transferred to the mirror source CM 5-1 has a BCC 105 added thereto that includes a CRC 107 calculated by the CA 7-1.

In S9, the receiving unit 33 of the mirror source CM 5-1 sets the CRC recalculation flag 47 to OFF.

In S41, the load comparison unit 49 of the mirror source CM 5-1 determines whether or not the value of the mirror destination load counter 53 is equal to or greater than the value of the mirror source load counter 51.

When the value of the mirror destination load counter 53 is less than the value of the mirror source load counter 51 (NO in S41), processing moves to S19 described hereafter.

When the value of the mirror destination load counter 53 is equal to or greater than the value of the mirror source load counter 51 (YES in S41), in S13 the copy unit 35 of the mirror source CM 5-1 sets the CRC recalculation flag 47 to ON, and processing moves to S19.

In S19, the copy unit 35 of the mirror source CM 5-1 transmits a copy of the data block to the mirror destination CM 5-2, and the copy is stored as mirror data in the mirror destination CM 5-2.

In S21, the recalculation unit 37 of the mirror source CM 5-1 determines whether or not the CRC recalculation flag 47 is ON.

When the CRC recalculation flag 47 is ON (YES in S21), in S45 the recalculation unit 37 of the mirror source CM 5-1 increments the mirror source load counter 51 by one.

Next, in S47, the recalculation unit 37 of the mirror source CM 5-1 recalculates the CRC 107 of the data block received from the CA 7-1.

When the CRC recalculation has finished, in S49, the recalculation unit 37 of the mirror source CM 5-1 decrements the mirror source load counter 51 by one.

In S25, the comparison unit 39 of the mirror source CM 5-1 compares the CRC 107 recalculated in S47 and the CRC 107 included in the data received from the CA 7-1, and determines whether or not these CRCs 107 match.

When the CRCs 107 match (YES in S25), in S27 the comparison unit 39 of the mirror source CM 5-1 increments the data counter 43 by one.

When the CRCs 107 do not match (NO in S25), processing moves to S35 described hereafter.

Next, in S29, the comparison unit 39 of the mirror source CM 5-1 determines whether or not the value of the data counter 43 is equal to the value of the total block number indicator 45.

When the value of the data counter 43 is not equal to the value of the total block number indicator 45 (NO in S29), because there is an unreceived data block, processing returns to the aforementioned S7, and the reception of the remaining data blocks is continued.

When the value of the data counter 43 is equal to the value of the total block number indicator 45 (YES in S29), because all of the data blocks have been completely received, in S31 the CA 7-1 issues a data reception completion response to the host device 21.

When the CRC recalculation flag 47 is OFF (NO in S21), recalculation of the CRC 107 is carried out by the recalculation unit 37 of the mirror destination CM 5-2.

In S33, the recalculation unit 37 of the mirror source CM 5-1 determines whether or not the CRC 107 recalculated in the mirror destination CM 5-2 matches the CRC 107 added by the CA 7-1.

When the CRC 107 recalculated in the mirror destination CM 5-2 matches the CRC 107 added by the CA 7-1 (YES in S33), processing moves to S27 described above.

When the CRC 107 recalculated in the mirror destination CM 5-2 does not match the CRC 107 added by the CA 7-1 (NO in S33) or when the CRCs 107 do not match (NO in S25), in S35 the erasure unit 41 of the mirror source CM 5-1 issues notification of invalid mirror processing to the mirror destination CM 5-2.

Next, in S39, a CA 7 issues a data reception failure response to the host device 21.

The processing of the mirror destination CM 5-2 in the storage device 3 as an example of the second embodiment is similar to the processing in the example of the first embodiment depicted in FIGS. 4 and 5, except for the point that the mirror destination load counter 53 is increased or decreased before and after the CRC recalculation in the mirror destination CM 5-2. Therefore, the processing of the mirror destination CM 5-2 is not depicted and a description thereof will be omitted.

According to the example of the second embodiment, in addition to the benefits of the example of the first embodiment, it is possible to distribute the CRC recalculation processing between the CMs 5 in accordance with the loads of respective CMs 5.

It is therefore possible to further shorten the response time from the storage device 3 to the host device 21.

### Other Embodiments

Regardless of the aforementioned embodiments, a variety of modifications may be implemented without deviating from the purpose of the present embodiments.

CRC recalculation is carried out by two CMs 5 in the first and second embodiments; however, in order to reduce the load of the mirror source CM 5-1, when three or more CMs 5 are mounted, CRC recalculation may be executed by the three or more CMs 5.

The shared ratio of the CRC recalculation of the mirror source CM 5-1 and the mirror destination CM 5-2 is 1:1 in the first embodiment; however, the mirror destination CM 5 may distribute the CRC recalculation processing so that the load becomes 1:N as a result of additional distribution to another CM 5.

Moreover, in the second embodiment, the CRC recalculation processing by the CMs 5 is allocated in accordance with the number of processes being executed by the CPUs 9 of the CMs 5; however, the allocation of the CRC recalculation processing is not restricted to this approach. For example, when the utilization rate of the CPU 9-1 of the mirror source CM 5-1 exceeds a load distribution starting threshold, the CRC recalculation processing may be allocated to the mirror destination CM 5-2, and when the utilization rate of the CPU 9-1 of the mirror source CM 5-1 has fallen below the load distribution starting threshold, the CRC recalculation processing may be carried out by the mirror source CM 5-1.

In order to reduce the number of times the CRC recalculation processing is executed, CRC recalculation processing is executed for all data when the storage device 3 is first introduced; however, if the checking is successfully carried out a number of times that is equal to or greater than a fixed number of times, the frequency at which the CRC recalculation is carried out may be gradually reduced.

The program (management program) for implementing functions as the processing unit 31, the receiving unit 33, the copy unit 35, the recalculation unit 37, the comparison unit 39, the erasure unit 41, and the load comparison unit 49 is, for example, provided recorded on a computer-readable recording medium such as a flexible disk, compact discs (CDs) including a CD-ROM, a CD recordable (CD-R), CD-ReWritable (CD-RW), and so on), digital versatile disks (DVDs) including DVD-ROM, DVD-RAM, DVD-R, DVD+R, DVD-RW, DVD+RW, HD DVD, and so on, a Blu-ray Disc, a magnetic disk, an optical disk, or a magneto-optical disk. The computer reads the program from the recording medium, transfers and stores the program in an internal storage device or an external storage device, and uses the program. Alternatively, for example, the program may be recorded on a storage device (recording medium) such as a magnetic disk, an optical disk, or a magneto-optical disk, and provided to the computer by way of a communication path from that storage device.

When implementing functions as the processing unit 31, the receiving unit 33, the copy unit 35, the recalculation unit 37, the comparison unit 39, the erasure unit 41, and the load comparison unit 49, the program stored in the internal storage device (memory 11 of a CM 5 in the present embodiments) is executed by a microprocessor (a CPU 9 of a CM 5 in the present embodiments) of the computer. The computer may read and execute the program recorded in the recording medium.

The memory 11 of a CM 5 in the present embodiments functions as the data counter 43, the total block number indicator 45, the CRC recalculation flag 47, the mirror source load counter 51, and the mirror destination load counter 53.

In the present embodiments, a computer is a notion including hardware and an operating system, and signifies hardware that operates under the control of the operating system. Alternatively, in the case that an operating system is not necessitated and the hardware is operated independently by an application program, the hardware itself is equivalent to a computer. The hardware is at least provided with a microprocessor such as a CPU, and a way of reading a computer program recorded on a recording medium, and in the present embodiments, the CMs 5 function as computers.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage device comprising:
a plurality of control devices configured to control writing data into one or more storages, the plurality of control devices each including:
an interface unit configured to transmit and receive data, and
a processor configured to
acquire first checking information added to first data to be written into a first storage,
acquire second checking information calculated based on the first data,
compare the first checking information and the second checking information, and
report an error by way of the interface unit when a result of the comparison indicates inconsistency between the first checking information and the second checking information.

2. The storage device according to claim 1, wherein
the processor is configured to
write the first data into the first storage,
transfer a copy of the first data to a first control device, and
erase, when the result of the comparison indicates the inconsistency, the first data stored in the first storage and requests the first control device to erase the copy.

3. The storage device according to claim 1, wherein
the calculation of the second checking information is distributed and carried out using at least two of the plurality of control devices.

4. The storage device according to claim 1, wherein
the calculation of the second checking information is carried out in rotation using at least two of the plurality of control devices.

5. The storage device according to claim 1, wherein
the calculation of the second checking information is distributed in accordance with loads of at least two of the plurality of control devices.

6. The storage device according to claim 1, wherein
the first checking information is calculated by the interface unit, and
the second checking information is calculated by the processor.

7. A method for managing a storage device including a plurality of control devices that control writing data into one or more storages, the method comprising:
acquiring, by a first control device, first checking information added to first data to be written into a first storage;
acquiring second checking information calculated based on the first data;
comparing the first checking information and the second checking information; and
reporting an error when a result of the comparison indicates inconsistency between the first checking information and the second checking information.

8. The method according to claim 7, further comprising:
writing the first data into the first storage;
transferring a copy of the first data to a second control device; and
erasing, when the result of the comparison indicates the inconsistency, the first data stored in the first storage and requests the second control device to erase the copy.

9. The method according to claim 7, wherein
the calculation of the second checking information is distributed and carried out using at least two of the plurality of control devices.

10. The method according to claim 7, wherein
the calculation of the second checking information is carried out in rotation using at least two of the plurality of control devices.

11. The method according to claim 7, wherein
the calculation of the second checking information is distributed in accordance with loads of at least two of the plurality of control devices.

12. A computer-readable recording medium storing a program that causes a computer to execute a procedure, the computer being one of a plurality of computers included in a storage device for controlling writing of data into one or more storages, the procedure comprising:
acquiring first checking information added to first data to be written into a first storage;
acquiring second checking information calculated based on the first data;
comparing the first checking information and the second checking information; and
reporting an error when a result of the comparison indicates inconsistency between the first checking information and the second checking information.

13. The computer-readable recording medium according to claim 12, the procedure further comprising:
writing the first data into the first storage;
transferring a copy of the first data to a second control device; and
erasing, when the result of the comparison indicates the inconsistency, the first data stored in the first storage and requests the second control device to erase the copy.

14. The computer-readable recording medium according to claim 12, wherein
the calculation of the second checking information is distributed and carried out using at least two of the plurality of control devices.

15. The computer-readable recording medium according to claim 12, wherein
the calculation of the second checking information is carried out in rotation using at least two of the plurality of control devices.

16. The computer-readable recording medium according to claim 12, wherein
the calculation of the second checking information is distributed in accordance with loads of at least two of the plurality of control devices.
